(19) United States
(12) Patent Application Publication
(10) Pub. No.: US 2009/0033754 A1
(43) Pub. Date: Feb. 5, 2009

(54) SIGNAL PROCESSING CIRCUIT AND IMAGE SHOOTING APPARATUS

(76) Inventor: Hiroki YOSHIKAWA, Kyoto (JP)

Correspondence Address: MCDERMOTT WILL & EMERY LLP, 600 13TH STREET, NW, WASHINGTON, DC, 20005-3096, US

(21) Appl. No.: 12/184,476

(22) Filed: Aug. 1, 2008

(30) Foreign Application Priority Data
Aug. 2, 2007 (JP) 2007-202036

(51) Int. Cl. H04N 5/225; G09G 5/36

(52) U.S. Cl. 348/220.1; 345/545; 348/E05.024

(57) ABSTRACT

The signal processing circuit includes: a buffer memory for temporarily storing a shot image; and a moving-picture detection device for detecting whether or not the shot image is a moving picture. Whether to store the shot image in the buffer memory as a moving memory, as a still picture, or as both a moving picture and a still picture is determined according to the detection result of the moving-picture detection device.

### BACKGROUND OF THE INVENTION

1. Field of the Invention

The present invention relates to a signal processing circuit for processing both a still picture and a moving picture.

2. Description of the Prior Art

In recent years, digital still cameras have been increasingly given the ability of shooting a moving picture with as high quality as that shot by digital video cameras. Also, an image processing device permitting shooting of a still picture during shooting of a moving picture has been proposed. For example, proposed is an image processing device in which a still picture and a moving picture are compressed under different schemes and stored in separate regions of a memory medium, to enable enhancement of the resolution of the still picture shot during shooting of the moving picture (see Japanese Laid-Open Patent Publication No. 10-200859, for example, which is hereinafter referred to as Patent Document 1).

There is also proposed an electronic camera in which to record the atmosphere before and after shooting of a still picture of an object, a moving picture is automatically shot before and after the shooting of the still picture (see Japanese Laid-Open Patent Publication No. 2001-78137, for example, which is hereinafter referred to as Patent Document 2). In this electronic camera, which is provided with a two-stage press type release button, shooting of a moving picture is started in response to half-press operation. A still picture is shot in response to full-press operation, and a predetermined time after the full-press operation, the shooting of the moving picture is terminated. Patent Document 2 also describes a configuration provided with, not the two-stage press type release button, but both a button for still-picture shooting and a button for moving-picture shooting separately.

However, in recording a moving picture taken before and after shooting of a still picture, the following problem arises. When an object that changes little, such as a landscape, is to be recorded as a moving picture, a considerable amount of a recording medium will be consumed although there is little merit in storing such a moving picture.

Also, the user must determine in advance whether to store an image as a moving picture or as a still picture and designate the mode with a mode dial and the like.

### SUMMARY OF THE INVENTION

An object of the present invention is providing a signal processing circuit in which, in recording of a moving picture taken before and after shooting of a still picture, the storage style is determined from predetermined conditions to thereby minimize consumption of a recording medium and the user-desired shooting mode can be automatically determined.

The signal processing circuit of the present invention includes: a buffer memory for temporarily storing a shot image; and a moving-picture detection device for detecting whether or not the shot image is a moving picture, wherein whether to store the shot image in the buffer memory as a moving picture, as a still picture or as both a moving picture and a still picture is determined according to the detection result of the moving-picture detection device.

Alternatively, the signal processing circuit of the present invention includes a moving-picture detection device for detecting whether or not a shot image is a moving picture, wherein whether to display the shot image as a moving picture or a still picture is determined according to the detection result from the moving-picture detection device.

### BRIEF DESCRIPTION OF THE DRAWINGS

FIG. 1 is a view showing a basic configuration of an image shooting apparatus 100 of an embodiment of the present invention.

FIG. 2 is a view illustrating the appearance of the image shooting apparatus 100.

FIG. 3 is a brief flowchart showing shooting operation.

FIG. 4 is a view illustrating the outline of the operation starting from pressing of a shutter button until storage of an image.

FIG. 5A is a view showing an example of playlist.

FIG. 5B is a view showing an example of configuration of directories in an external recording medium 170.

FIG. 6 is a flowchart of storage style determination processing.

FIG. 7 is a view showing the relationship between the code amount and the shooting time of a moving picture.

FIG. 8A is a view showing how to determine the storage style from the motion amount.

FIG. 8B is a view demonstrating the time interval at which the motion amount is detected.

FIG. 9 is a flowchart showing the processing of deleting portions of a moving picture during predetermined time periods at the start and end of the shooting.

FIG. 10A is a view showing how to determine the storage style from the pattern and size of the face.

FIG. 10B is a view illustrating an example of face pattern.

FIG. 11 is a flowchart showing the processing of determining the playback style.

### DESCRIPTION OF THE PREFERRED EMBODIMENTS

Hereinafter, a preferred embodiment of the present invention will be described with reference to the accompanying drawings.

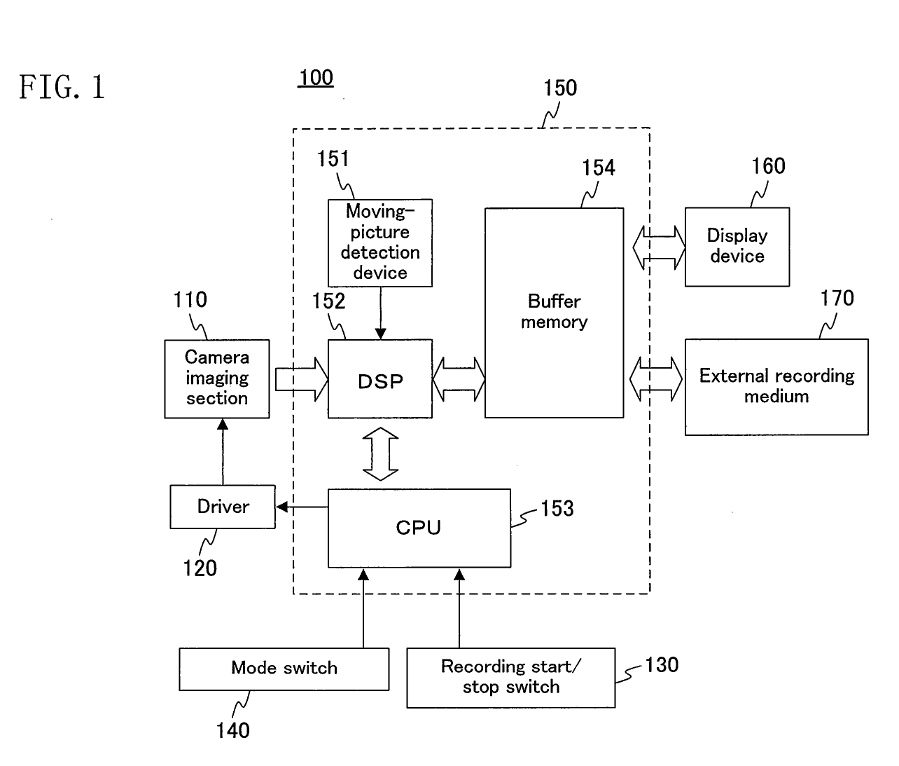

FIG. 1 is a view showing a basic configuration of an image shooting apparatus 100 of an embodiment of the present invention. Referring to FIG. 1, the image shooting apparatus 100 includes a camera imaging section 110, a driver 120, a recording start/stop switch 130, a mode switch 140, a signal processing circuit 150, a display device 160 and an external memory medium 170.

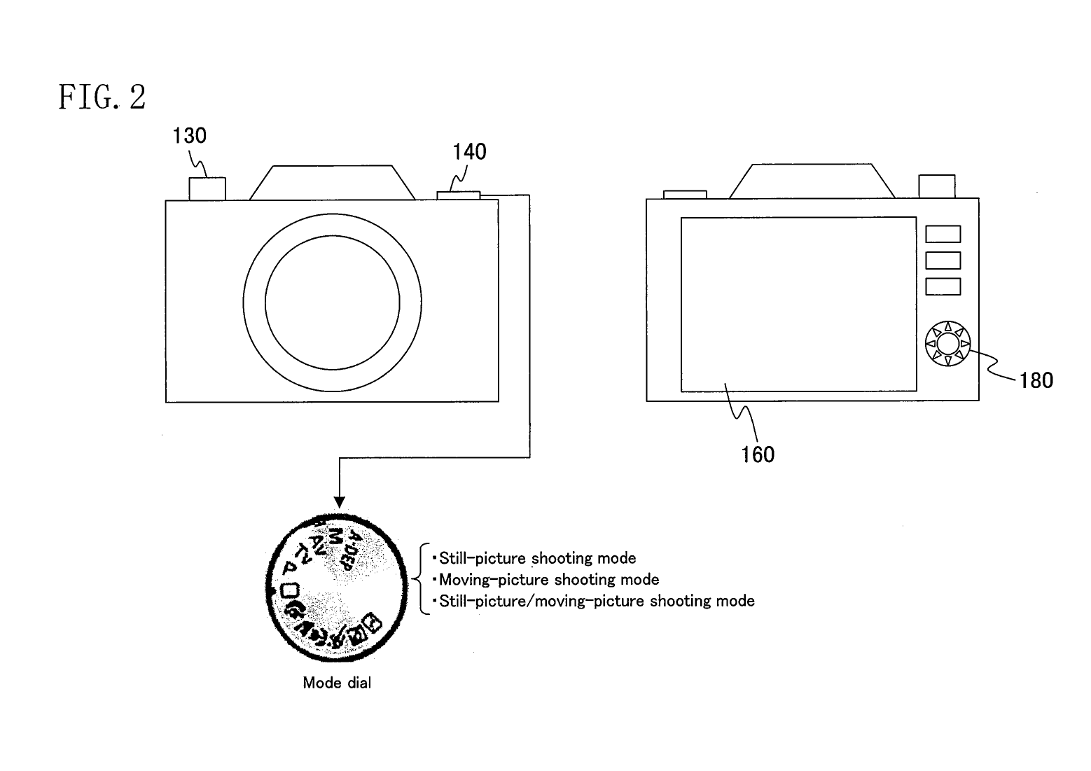

FIG. 2 illustrates the appearance of the image shooting apparatus 100. The recording start/stop switch 130 (shutter button), the mode switch 140 (mode dial) and the display device 160 of the image shooting apparatus 100 are placed as shown in FIG. 2, to allow the user to operate the recording start/stop switch 130 and the mode switch 140 and check the displayed details on the display device 160. The image shooting apparatus 100 is also provided with a menu selection key switch 180.

(Configurations of Components of Image Shooting Apparatus 100)

The camera imaging section 110 converts the object to be shot to an electric signal and outputs the signal. Specifically, the camera imaging section 110 is composed of a projection lens, an aperture, a CCD imaging device, a correlated double sampling circuit and the like.

The driver 120 controls the camera imaging section 110.

The recording start/stop switch 130 has a two-stage structure permitting half-press (first release) operation and full-press (second release) operation. In this embodiment, the half-press operation of the recording start/stop switch 130 is recognized by the signal processing circuit 150 (specifically, a CPU 153 to be described later) as start of shooting of a moving picture, and the full-press operation is recognized as start of shooting of a still picture.

The mode switch 140 is a switch for changing the mode among a still-picture shooting mode, a moving-picture shooting mode and a still-picture/moving-picture automatic shooting mode. The user can operate the mode switch 140 to freely select the shooting mode or use the still-picture/moving-picture automatic shooting mode to leave determination on whether to store a moving picture or a still picture to the imaging apparatus.

Although the three modes, the still-picture shooting mode, the moving-picture shooting mode and the still-picture/moving-picture automatic shooting mode, are provided in this embodiment, the modes are not necessarily limited to these three. For example, only the still-picture/moving-picture automatic shooting mode may be adopted, or another mode (e.g., a landscape shooting mode) may be added. In this embodiment, the still-picture/moving-picture automatic shooting mode will be especially described in detail.

The signal processing circuit 150 performs generation of Y (luminance) and Cb, Cr (color difference) signals and other processing from the electric signal outputted from the camera imaging section 110. In the illustrated example, the signal processing circuit 150 includes a moving-picture detection device 151, a digital signal processor (DSP) 152, the central processing unit (CPU) 153 and a buffer memory 154.

The moving-picture detection device 151 detects whether or not a shot image is a moving picture. In this embodiment, the moving-picture detection device 151 performs detection of the code amount, the motion amount, a blurred image and a face.

The DSP 152 performs A/D conversion and various kinds of image processing.

The CPU 153 examines the results of the signal processing and controls the entire apparatus. For example, the CPU 153 determines whether to store the shot image as a moving picture, as a still picture or as both a moving picture and a still picture based on the detection result of the moving-picture detection device 151.

The buffer memory 154 stores the shot image therein.

The display device 160 displays the contents of the buffer memory.

The external recording medium 170 stores the shot image. Examples of the external recording medium 170 include a SD card, a multimedia card and a hard disk.

(Operation of Image Shooting Apparatus 100)

The basic operation of the image shooting apparatus 100 is as follows. First, in the camera imaging section 110, the image of the object captured via the projection lens is inputted into the imaging device to be converted to an electric signal. The resultant signal from the imaging device is outputted to the DSP 152 via the correlated double sampling circuit.

In the DSP 152, the inputted signal is converted to an optimum digital signal via an A/D conversion circuit and a signal processing circuit. The digital signal is then processed inside the signal processing circuit 150 to produce a Y (luminance) and Cb, Cr (color difference) signals.

The above signals are temporarily held in the buffer memory 154, and after being subjected to compression of image data, stored in the external recording medium 170. The image data temporarily held in the buffer memory 154 can be displayed on the display device 160.

Next, the operation of capture of a moving picture and shooting of a still picture will be described.

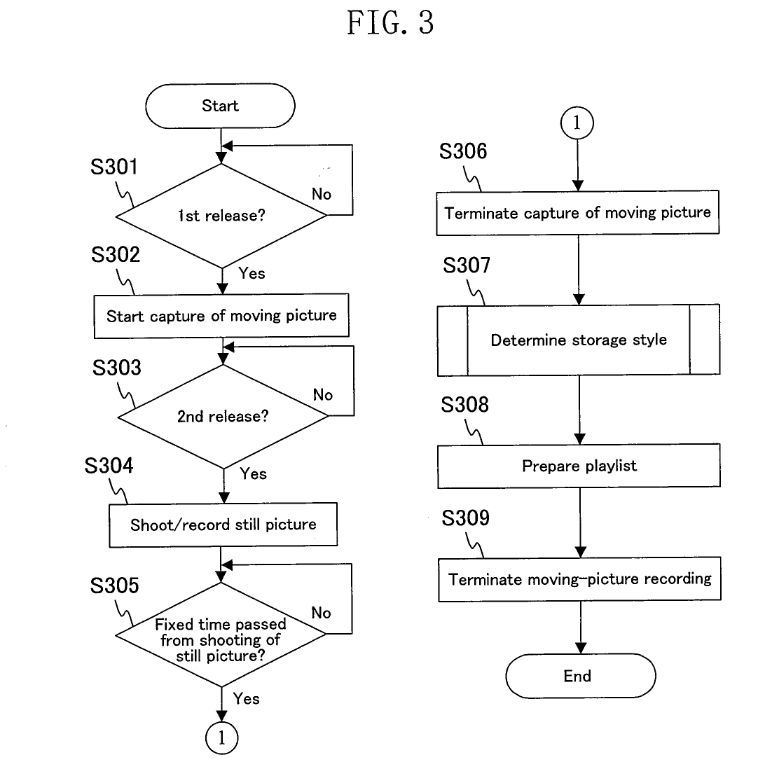

FIG. 3 is a simple flowchart of the shooting operation. Before start of the shooting operation, the user dials the mode to the moving-picture/still-picture automatic shooting mode with the mode switch 140. The shooting is started by pressing the recording start/stop switch 130.

In step S301, whether or not the recording start/stop switch 130 is in the half-pressed state is determined. If so, the process proceeds to step S302 (start capture of moving picture). Otherwise, monitoring for determination of the half-pressed state is continued.

In the step S302, capture of a moving picture is started, and the process moves to step S303.

In the step S303, whether or not full-press operation has been made is determined. If so, the process proceeds to step S304 (shoot/record still picture). Otherwise, monitoring for determination of the full-pressed state is continued.

In the step S304, a still picture is shot/recorded. In the next step S305, whether or not a fixed time has passed from the start of shooting of the still picture is determined.

If it is determined that the fixed time has passed, the process proceeds to step S306 to terminate the capture of the moving picture. Otherwise, the recording of the moving picture is continued until the end of the fixed time. In other words, the recording of the moving picture is terminated after the lapse of the fixed time.

The process then proceeds to step S307, where the storage style is determined (details of this determination will be described later) and the image is stored according to the determination result. After the storage of the image in the step S307, a playlist is prepared in step. S308. If a playlist has already been prepared, addition to the playlist is made. Once the preparation of (or addition to) a playlist is terminated, processing for terminating the recording of the moving picture is performed in step S309, to terminate the moving-picture recording.

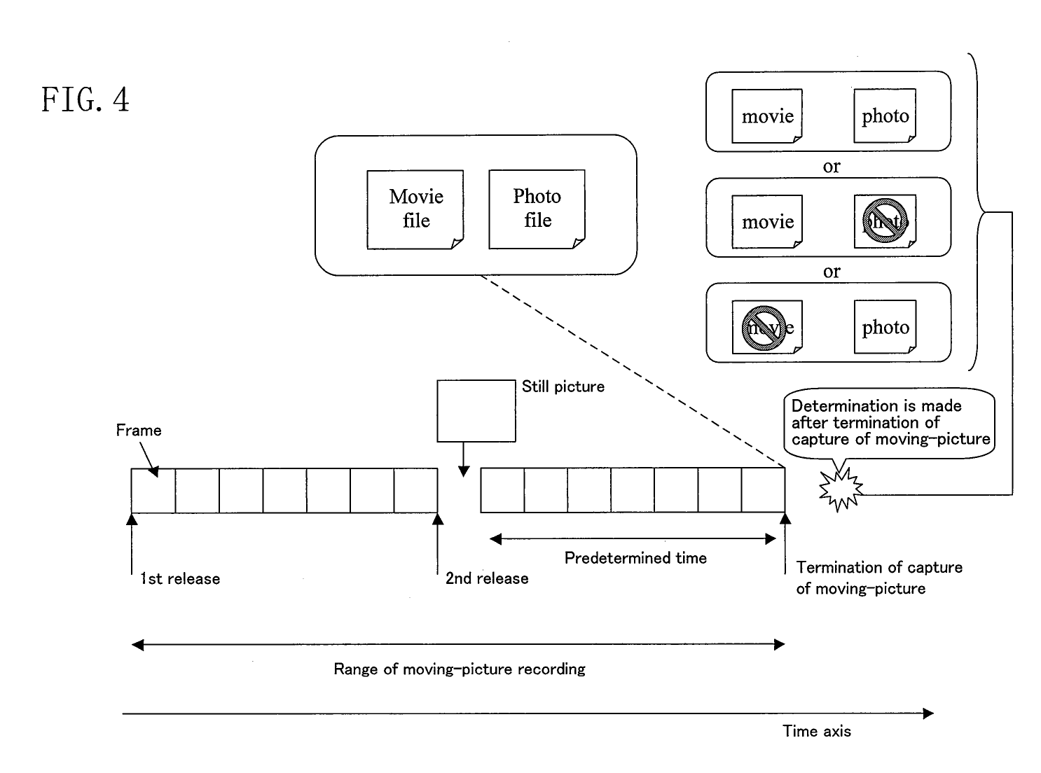

Next, the timing of determination of the storage style and the like will be described. FIG. 4 is a view illustrating the outline of the operation performed from pressing of the shutter button until storing of an image.

Recording of a moving picture is started with the first release (half-press). A still picture is shot with the second release (full-press), and the capture of the moving picture is terminated after the lapse of a predetermined time. At this time, still-picture data and moving-picture data are stored in the buffer memory 154. If the capacity of the buffer memory 154 is short, such data may be temporarily stored in the external recording medium 170.

The timing of determination of the storage style is after the termination of capture of the moving picture as shown in FIG. 4. Determination is made on whether to store the image as a moving picture, as a still picture or as both a moving picture and a still picture.

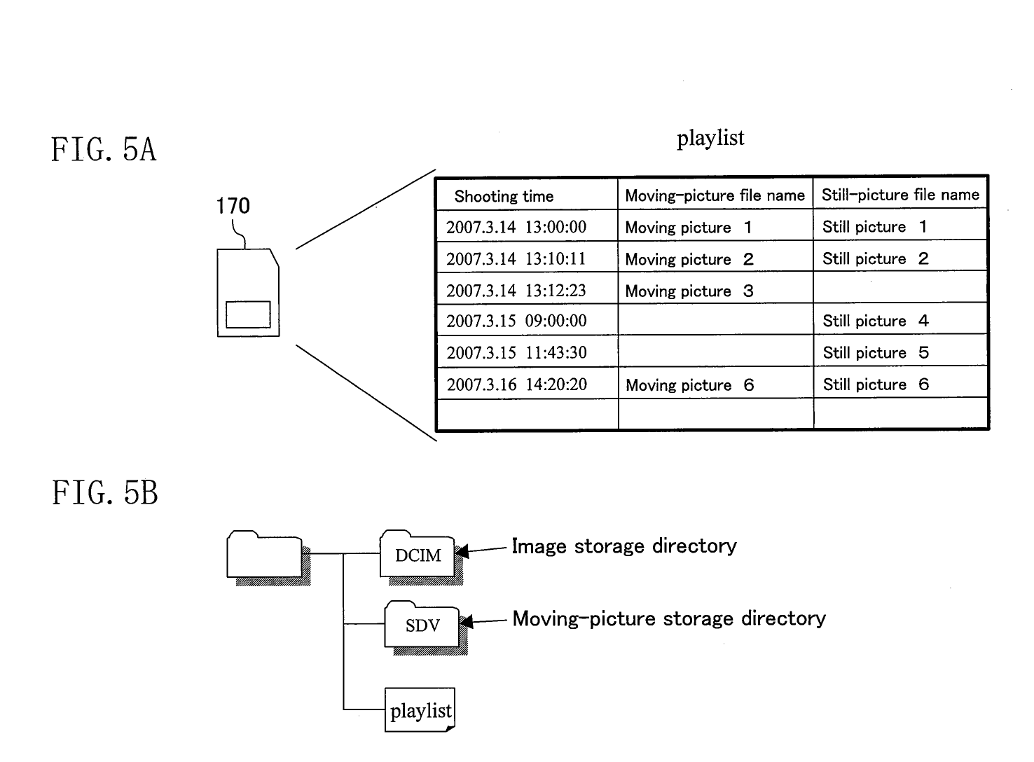

In the case of storing both, a moving-picture file and a still-picture file are stored separately. The stored moving-picture and still-picture files are managed in the form of a playlist, to thereby permit recognition of the correspondence between the moving-picture file and the still-picture file. An example of playlist is shown in FIG. 5A. The playlist is stored in the external recording medium 170, to manage files held in an image storage directory and a moving-picture storage directory as shown in FIG. 5B.

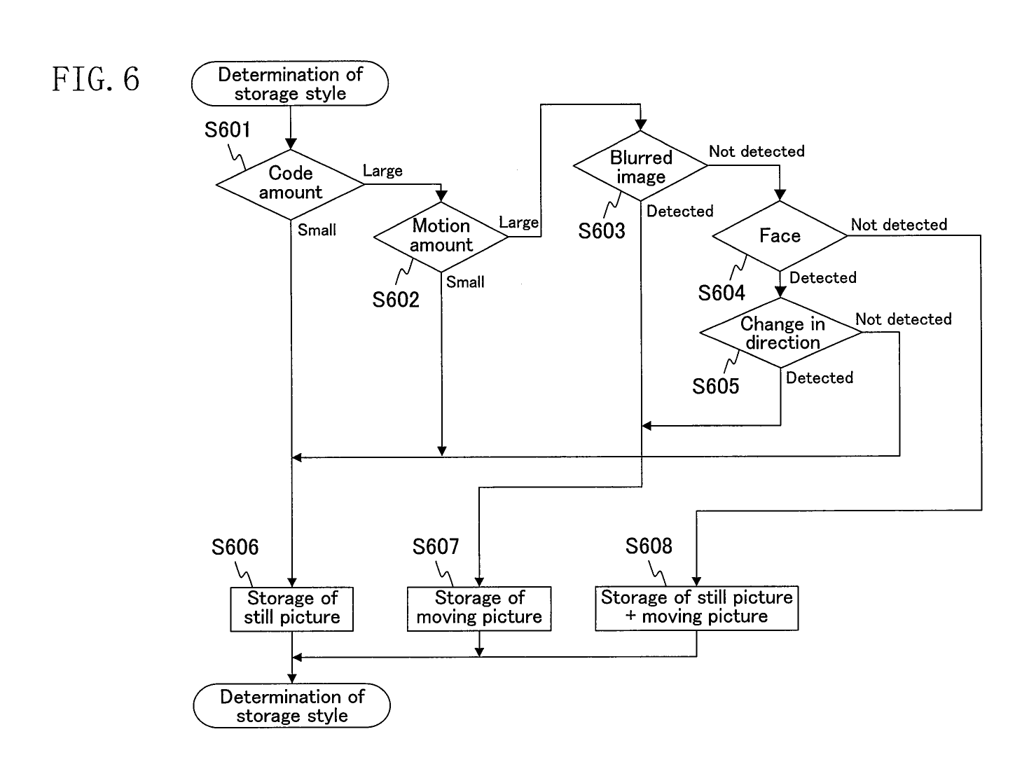

FIG. 6 shows a flowchart of the storage style determination processing in the step S307 described above.

First, in step S601, the code amount is detected. If the code amount is smaller than a predetermined threshold as a result of the detection, the process proceeds to step S606 (processing of storing a still picture). If the code amount is greater than the predetermined threshold, the process proceeds to step S602 (processing of detecting the motion amount).

In the step S602, the motion amount of the object is detected. If the motion amount detected in the step S602 is smaller than a predetermined threshold, the process proceeds to the step S606 (processing of storing a still picture). If the motion amount is greater than the predetermined threshold, the process proceeds to step S603 (processing of detecting a blurred image).

In the step S603, whether a blurred image exists or not is detected. If a blurred image is detected as a result of the detection, the process proceeds to step S607 (processing of storing a moving image). If no blurring is detected, the process proceeds to step S604 (processing of detecting a face).

In step S604, whether a face exists or not is detected. If a face is detected as a result of the detection, the process proceeds to step S605 (processing of detecting a change in face direction). If no face is detected, the process proceeds to step S608 (processing of storing both a still picture and a moving picture).

In the step S605, whether a change in face direction is observed or not is detected. If a change in face direction is detected as a result of the detection, the process proceeds to the step S607 (processing of storing a moving picture). If no change is detected, the process proceeds to the step S606 (processing of storing a still picture). There are available three storage styles: the moving-picture storage style, the still-picture storage style and the moving-picture/still-picture storage style. Different files are prepared for a moving picture and a still picture. In the case of storing both a moving picture and a still picture, also, the moving picture is stored as a moving-picture file while the still picture is stored as a still-picture file.

The determination of the storage style according to the code amount as described above is based on the following idea. That is, in shooting of a landscape and the like, in general, there is little change in the motion of the object to be shot. Hence, in an image shooting apparatus that shoots a still picture during shooting of a moving picture, it is considered that there is little merit in storing the moving picture and, by storing only the still picture, the capacity of the recording medium can be reduced.

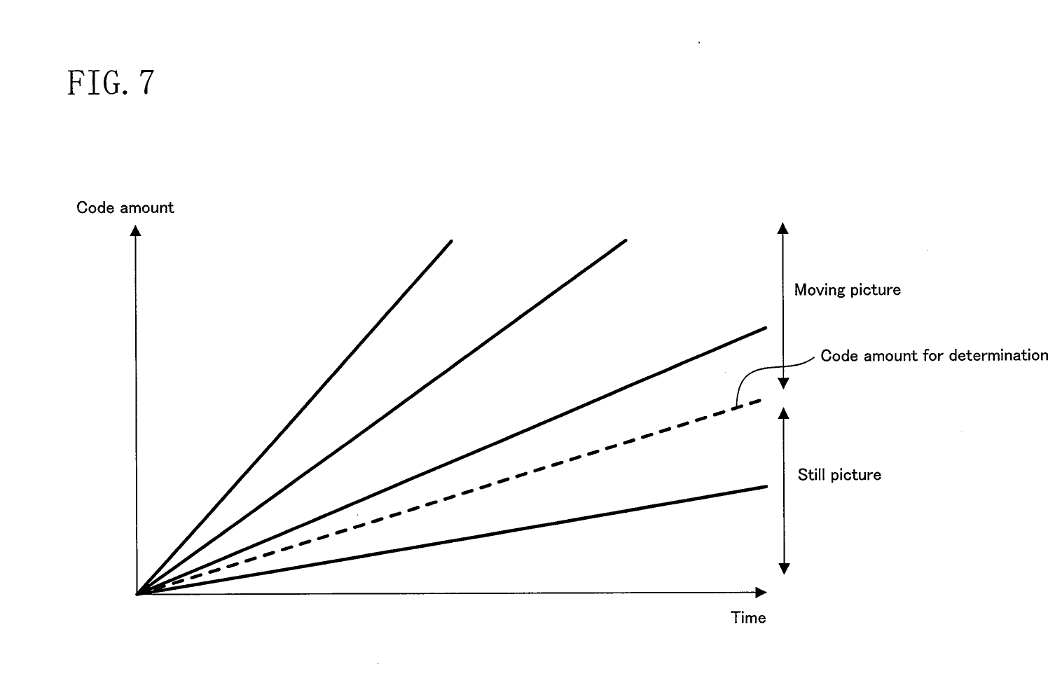

As shown in FIG. 7, while the code amount of a moving picture increases with increase of the shooting time, the increase in code amount is smaller if the object changes little. Based on this idea, the threshold of the code amount for determination on whether to store the image as a moving picture or a still picture is set in advance. The threshold of the code amount may be decided as a predetermined value, or may be decided from the relationship between the time and the code amount defined as an expression. If the code amount of a shot moving picture exceeds the threshold, the image is stored as a moving picture. If it is equal to or less than the threshold, it is stored as a still picture.

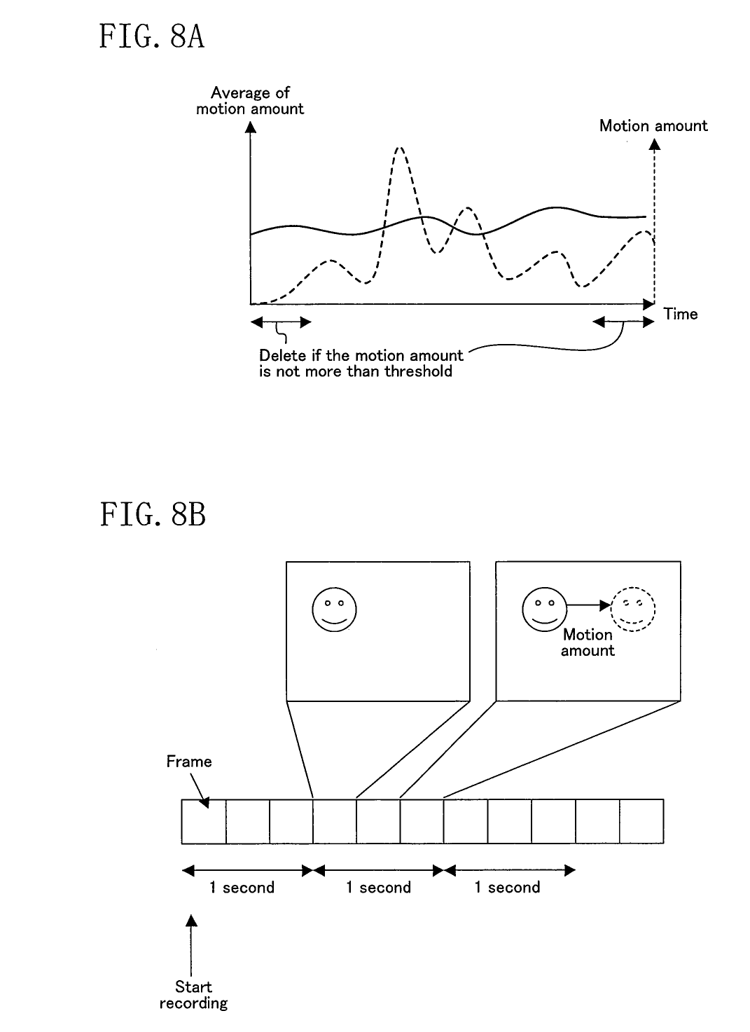

The idea of using the motion amount for determination of the storage style is similar to that for the code amount. FIG. 8A shows how to determine the storage style from the motion amount. In the image shooting apparatus 100, the motion amount is detected every predetermined time interval (e.g., every second) during shooting (see FIG. 8B). More specifically, both the motion amount per second and the motion amount per unit time (average motion amount in a shooting time) are measured. If the motion amount per second and the motion amount per unit time exceed a predetermined motion amount (threshold), the image is stored as a moving picture. Otherwise, it is stored as a still picture.

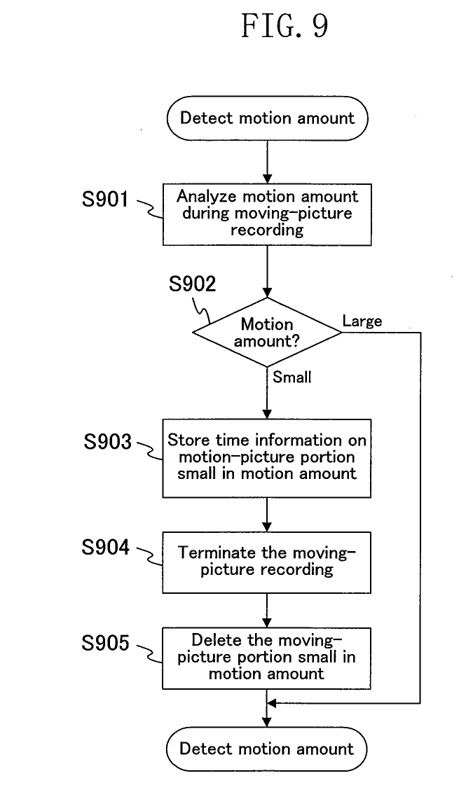

Portions of a moving picture shot during predetermined time periods at the start and end of the shooting may be deleted if the motion amount is small. With this deletion, in shooting of a video letter and the like, it is possible to delete scenes at the start and end of the shooting that may be unnecessary for the user. Also, in the case that the motion amount suddenly increases during shooting, such an image may be stored as moving-picture recording. That is, the sudden increase in the motion amount of the object implies that the merit of leaving the image as a moving picture has risen, and thus the image is stored as a moving picture. FIG. 9 shows the details of this processing.

In step S901, the motion amount during motion-picture recording is analyzed. This corresponds to a step of calculating the motion amount per unit time.

In step S902, whether or not the motion amount is equal to or less than a predetermined threshold is determined. If the motion amount is equal to or less than the predetermined threshold (moving picture small in motion amount), the process proceeds to step S903, where the time information on the portion of the moving picture small in motion amount is stored. The information is not limited to the time information but may be any information that can specify the moving-picture portion.

The process then proceeds to step S904, where the moving-picture recording is terminated. Thereafter, in step S905, the portion of the moving picture small in motion amount is deleted.

Next, how to determine the storage style from a blurred image will be described. In shooting of a still picture during moving-picture shooting, if the image has been recorded as a blurred image, there is little merit in storing such a still picture. However, if the image has been recorded as a moving picture including the situation before and after the shooting of the still picture, there is merit in leaving the image as a moving picture. The still picture may therefore be deleted leaving only the moving picture behind, to permit reduction in the capacity of the recording medium. Whether the image is blurred or not is determined under image processing. A blurred image is generally blurred and small in high frequency component.

A technology of correcting a blurred image with a statistical technique has been developed. In an image shooting apparatus equipped with such a correction technology, if a blurred image is detected and it is determined to store the image as a still picture from the code amount and the motion amount, both the still picture and the moving picture are left behind.

Instead of a blurred image, sound and light may be used as detection means. Control may be made to store the image as a moving picture if sound and light are detected. For example, control may be made to store a situation with heavy sound, which must be a powerful scene, as a moving picture.

How to determine the storage style from face detection will then be described. When a face is detected, a change in the direction of the face is detected to determine whether to store the image as a moving picture or a still picture. This is because a change in face direction implies active motion, and thus it is considered that there is merit in storing the image as a moving picture. If no change is detected in the face direction, this implies that the object is at rest looking at the image shooting apparatus, and thus the merit is considered higher in storing the image as a still picture.

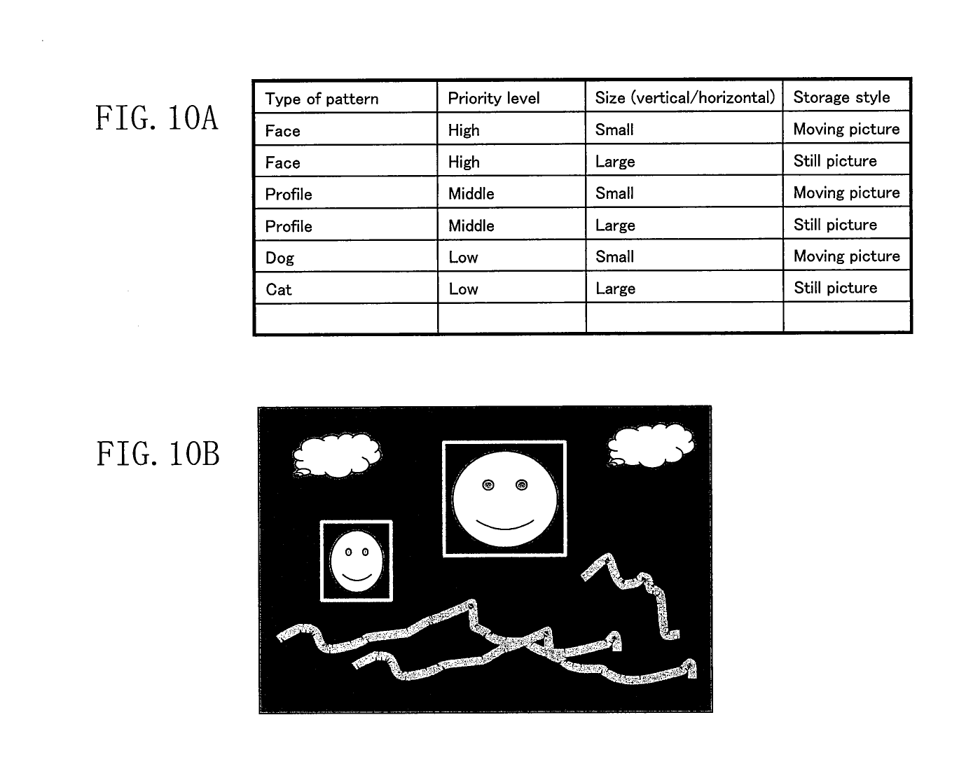

In the face detection, control may be made to record the image as a moving picture once a face is detected. Otherwise, the motion amount of the detected region may be measured to control switching to moving-picture recording. More specifically, as shown in FIGS. 10A and 10B, the storage style may be determined from the pattern and size of a face. Otherwise, the priority level may be given in advance to each pattern, and a pattern with higher priority may be recorded as a moving picture.

Next, the operation of determining the playback style will be described. In playback, the playlist prepared during recording is basically referred to. If no reference to a playlist is available, playback control is performed using the detection means of the code amount and the motion amount.

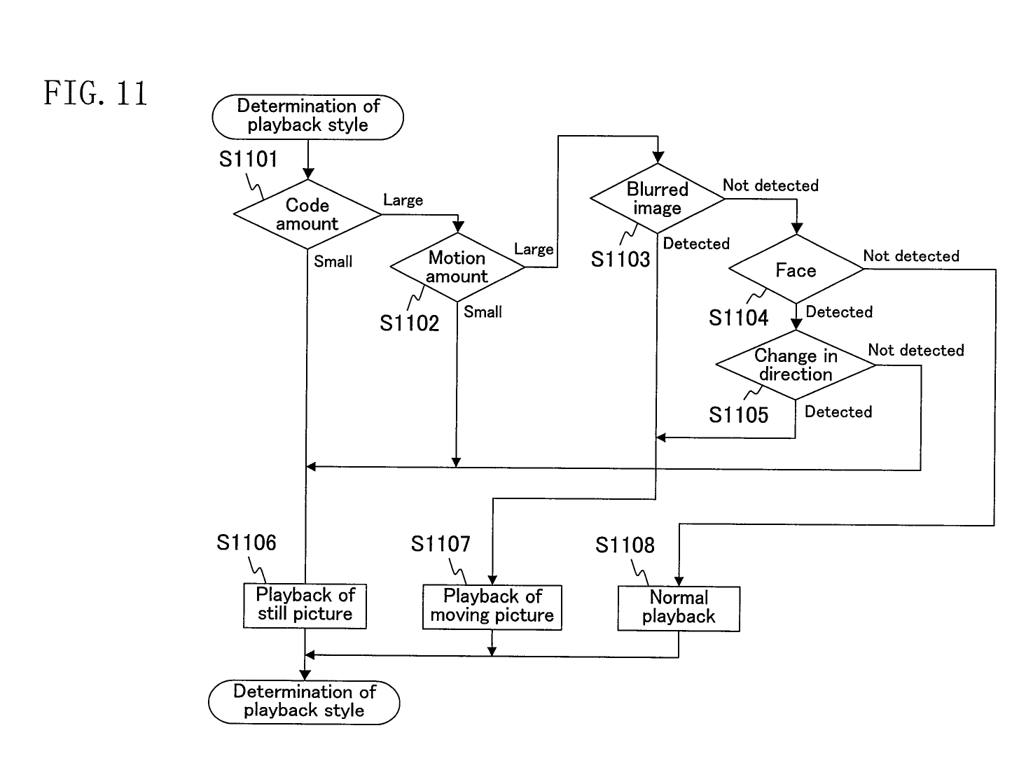

FIG. 11 is a flowchart showing processing of determining the playback style.

In step S1101, the code amount is determined. If the code amount is smaller than a predetermined threshold, the process proceeds to step S1106, where the image is played back as a still picture. If the code amount is greater than the predetermined threshold, the process proceeds to step S1102, where the motion amount is determined.

If the motion amount is smaller than a predetermined threshold as a result of the determination in the step S1102, the process proceeds to the step S1106, where the image is played back as a still picture. If the motion amount is greater than the predetermined threshold, the process proceeds to step S1103, where whether or not a blurred image exists is detected.

If a blurred image is detected as a result of the detection in the step S1103, the process proceeds to step S1107 if there exist a moving picture corresponding to this image, and the image is played back as a moving picture. If no blurring is detected, the process proceeds to step S1104, where whether or not a face exists is detected.

Once a face is detected in the step S1104, the process proceeds to step S1105, where whether or not a change in face direction is observed is detected. If a change in face direction is detected in the step S1105, the image is played back as a moving picture. Otherwise, the image is played back as a still picture. If the face detection condition is not satisfied in the step S1104, the process proceeds to step S1108, where normal playback is performed to play back a moving picture for a moving-picture file or a still picture for a still-picture file.

Note that in the image shooting apparatus 100, it is assumed that the corresponding moving-picture file and still-picture file exist. If no moving picture is available in moving-picture playback or no still picture is available in still-picture playback, the normal playback will be performed.

In playback of a still picture, control may be made not to play back an image if the image is blurred or is less valuable as an image in terms of light.

As described above, in this embodiment, in which whether or not to store a moving picture taken before and after shooting of a still picture is automatically determined, consumption of the recording medium can be minimized.

The present invention is not limited to the embodiment described above. For example, while memory reduction is intended in the above embodiment, the idea of adding information with extra recording may also be adopted.

The storage style may be determined in conjunction with the mode dial. For example, when the mode is the landscape shooting mode, control may be made to leave a still picture behind predominantly while deleting a moving picture.

Also, when the user takes an image through a viewfinder, it is necessary to prepare setting like storing the image as a still picture by use of a contact sensor.

As described above, the signal processing circuit of the present invention, which automatically determines whether or not to store a moving picture taken before and after shooting of a still picture of the object, has the effect of minimizing the consumption of the recording medium, and thus is useful as a signal processing circuit for performing processing of both a still picture and a moving picture, an image shooting apparatus incorporating the same and the like.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A signal processing circuit comprising:
a buffer memory for temporarily storing a shot image; and
a moving-picture detection device for detecting whether or not the shot image is a moving picture,
wherein whether to store the shot image in the buffer memory as a moving picture, as a still picture or as both a moving picture and a still picture is determined according to the detection result of the moving-picture detection device.

2. The signal processing circuit of claim 1, wherein the moving-picture detection device detects the code amount of an image and determines whether or not the shot image is a moving picture according to the detected code amount.

3. The signal processing circuit of claim 1, wherein the moving-picture detection device detects the motion amount of an image and determines whether or not the shot image is a moving picture according to the detected motion amount.

4. The signal processing circuit of claim 3, wherein if the motion amount of the image detected by the moving-picture detection device is smaller than a predetermined threshold, at least a start portion or an end portion of the moving picture is deleted.

5. The signal processing circuit of claim 1, wherein the moving-picture detection device detects the blur amount of an image and determines whether or not the shot image is a moving picture according to the detected blur amount.

6. The signal processing circuit of claim 1, wherein the moving-picture detection device detects a face portion of an image and a change in the direction of the detected face and determines whether or not the shot image is a moving picture according to the detected change in face direction.

7. The signal processing circuit of claim 1, wherein the moving-picture detection device detects a predetermined pattern and determines whether or not the shot image is a moving picture according to the priority level given in advance to each pattern.

8. The signal processing circuit of claim 1, wherein the moving-picture detection device prepares a playlist for display of an image including both a moving picture and a still picture.

9. A signal processing circuit comprising a moving-picture detection device for detecting whether or not a shot image is a moving picture,
wherein whether to display the shot image as a moving picture or a still picture is determined according to the detection result from the moving-picture detection device.

10. The signal processing circuit of claim 9, wherein the moving-picture detection device detects blur amount information of an image and determines whether or not the shot image is a moving picture according to the detected blur amount information.

11. The signal processing circuit of claim 9, wherein the moving-picture detection device detects code amount information of an image and determines whether or not the shot image is a moving picture according to the detected code amount information.

12. The signal processing circuit of claim 9, wherein the moving-picture detection device detects motion amount information of an image and determines whether or not the shot image is a moving picture according to the detected motion amount information.

13. An image shooting apparatus comprising:
the signal processing circuit of claim 1;
a camera imaging section for converting an object to be shot to an electric signal and outputting the result;
a mode switch for switching between a still-picture shooting mode, a moving-picture shooting mode and a still-picture/moving-picture shooting mode;
a shooting switch for indicating start of shooting;
a display device for displaying a shot image; and
an external recording medium for storing the shot image therein.
